(19) United States
(12) Patent Application Publication
(10) Pub. No.: US 2011/0286587 A1
(43) Pub. Date: Nov. 24, 2011

(54) CALL INFORMATION PROVIDING DEVICE, CALL INFORMATION PROVIDING SYSTEM, CALL INFORMATION PROVIDING METHOD, AND PROGRAM

(76) Inventors: Akihisa Kurashima, Tokyo (JP); Masato Yoshikawa, Tokyo (JP); Shingo Fukui, Tokyo (JP)

(21) Appl. No.: 13/147,334

(22) PCT Filed: Feb. 4, 2010
(86) PCT No.: PCT/JP2010/000679

§ 371 Date: Aug. 1, 2011

(30) Foreign Application Priority Data
Feb. 10, 2009 (JP) 2009-028671

(51) Int. Cl. H04M 11/00

(52) U.S. Cl. 379/88.13

(57) ABSTRACT

A call information providing system includes a voice data storage device and a call information providing device. The voice data storage device stores voice data indicating content of a call and a telephone number of a phone terminal used for a call so as to correspond to each other. The call information providing device transmits the information (or voice data itself), which specifies the voice data stored in the voice data storage device, to the email address of a user of the phone terminal used for the call by email. Accordingly, the content of the call and the email can be uniformly managed by the emailer of the email terminal.

### TECHNICAL FIELD

The present invention relates to a call information providing device, a call information providing system, a call information providing method, and a program capable of uniformly managing the content of a phone call and the content transmitted and received by email.

### BACKGROUND ART

There are phone calls and emails as tools for communication with others. Generally, the histories of phone calls and emails are separately managed.

Patent Document 1 discloses storing voice data recorded in a phone call temporarily in a built-in storage medium and then transmitting the voice data to a portable storage medium in the same apparatus.

In addition, Patent Document 2 discloses transmitting an email, which includes a caller telephone number and call arrival date and time, to the email address registered in advance when there is no answer to an incoming call.

### RELATED DOCUMENT

### Patent Document

[Patent Document 1] JP-A-2001-309055

[Patent Document 2] JP-A-2003-219469

### DISCLOSURE OF THE INVENTION

The content of a telephone conversation and the content transmitted and received by email may be linked with one another. In such a case, it may be convenient if the content of a phone call and the content transmitted and received by email can be uniformly managed.

The present invention has been made in view of the above-described problem, and it is an object of the present invention to provide a call information providing device, a call information providing system, a call information providing method, and a program capable of uniformly managing the content of a phone call and the content transmitted and received by email.

According to the present invention, there is provided a call information providing device comprising: an address storage unit which stores user identification information, which identifies telephone numbers of phone terminals or users of the phone terminals, so as to correspond to the email addresses of the users; a user information storage unit which stores user identification information, which identifies the users, so as to correspond to the telephone numbers; a user identification information receiving unit which receives the user identification information of any of the users; a telephone number reading unit which reads the telephone number, which corresponds to the user identification information received by the user identification information receiving unit, from the user information storage unit; a voice data acquisition unit which acquires, from a voice data storage unit which stores voice data indicating content of a call and the telephone number of the phone terminal used for the call so as to correspond to each other, information which specifies the voice data corresponding to the telephone number read by the telephone number reading unit; an address reading unit which reads an email address, which corresponds to the user identification information received by the user identification information receiving unit or the telephone number read by the telephone number reading unit, from the address storage unit; and an email transmission unit which transmits the information which specifies the voice data acquired by the voice data acquisition unit, as an email, to the email address read by the address reading unit.

According to the present invention, there is provided a call information providing device comprising: an address storage unit which stores telephone numbers of phone terminals so as to correspond to the email addresses of users of the phone terminals; an email address receiving unit which receives the email address of any of the users; a telephone number reading unit which reads the telephone number, which corresponds to the email address received by the email address receiving unit, from the address storage unit; a voice data acquisition unit which is connectable to a voice data storage unit, which stores voice data indicating content of a call and the telephone number of the phone terminal used for the call so as to correspond to each other, and which reads information, which specifies the voice data corresponding to the telephone number read by the telephone number reading unit, from the voice data storage unit; and an email transmission unit which transmits the information which specifies the voice data acquired by the voice data acquisition unit, as an email, to the email address received by the email address receiving unit.

According to the present invention, there is provided a call information providing device comprising: an address storage unit which stores telephone numbers of phone terminals so as to correspond to the email addresses of users of the phone terminals; a voice data acquisition unit which when a voice data storage unit, which stores voice data indicating content of a call and the telephone number of the phone terminal used for the call so as to correspond to each other, has stored the new voice data, acquires from the voice data storage unit, information which specifies the new voice data and the telephone number corresponding to the new voice data; an address reading unit which reads the email address, which corresponds to the telephone number acquired by the voice data acquisition unit, from the address storage unit; and an email transmission unit which transmits the information which specifies the new voice data acquired by the voice data acquisition unit, as an email, to the email address read by the address reading unit.

According to the present invention, there is provided a call information providing system comprising: a voice data storage device which stores voice data indicating content of a call and the telephone number of a phone terminal used for the call so as to correspond to each other; and a call information providing device which transmits information which specifies the voice data by email, and wherein the call information providing device includes: an address storage unit which stores user identification information, which identifies telephone numbers of phone terminals or users of the phone terminals, so as to correspond to the email addresses of the users; a user information storage unit which stores user identification information, which identifies the users, so as to correspond to the telephone numbers; a user identification information receiving unit which receives the user identification information of any of the users; a telephone number reading unit which reads the telephone number, which corresponds to the user identification information received by the user identification information receiving unit, from the user information storage unit; a voice data acquisition unit which acquires, from the voice data storage device, information which specifies the voice data corresponding to the telephone number read by the telephone number reading unit; an address reading unit which reads an email address, which corresponds to the user identification information received by the user identification information receiving unit or the telephone number read by the telephone number reading unit, from the address storage unit; and an email transmission unit which transmits the information which specifies the voice data acquired by the voice data acquisition unit, as an email, to the email address read by the address reading unit.

According to the present invention, there is provided a call information providing system comprising: a voice data storage device which stores voice data indicating content of a call and the telephone number of the phone terminal used for the call so as to correspond to each other; and a call information providing device which transmits information which specifies the voice data by email, and wherein the call information providing device includes: an address storage unit which stores telephone numbers of phone terminals so as to correspond to the email addresses of users of the phone terminals; an email address receiving unit which receives the email address of any of the users; a telephone number reading unit which reads the telephone number, which corresponds to the email address received by the email address receiving unit, from the address storage unit; a voice data acquisition unit which acquires information, which specifies the voice data corresponding to the telephone number read by the telephone number reading unit, from the voice data storage unit; and an email transmission unit which transmits the information which specifies the voice data acquired by the voice data acquisition unit, as an email, to the email address received by the email address receiving unit.

According to the present invention, there is provided a call information providing system comprising: a voice data storage device which stores voice data indicating content of a call and the telephone number of the phone terminal used for the call so as to correspond to each other; and a call information providing device which transmits information which specifies the voice data by email, and wherein the voice data storage device includes a voice data reading unit which when the new voice data has been stored, transmits to the call information providing device, information which specifies the new voice data and the telephone number corresponding to the new voice data, and the call information providing device includes: an address storage unit which stores telephone numbers of phone terminals so as to correspond to the email addresses of users of the phone terminals; a voice data acquisition unit which acquires from the voice data storage device, information which specifies the new voice data and the telephone number corresponding to the new voice data; an address reading unit which reads the email address, which corresponds to the telephone number acquired by the voice data acquisition unit, from the address storage unit; and an email transmission unit which transmits the information which specifies the new voice data acquired by the voice data acquisition unit, as an email, to the email address read by the address reading unit.

According to the present invention, there is provided a call information providing method comprising: storing voice data indicating content of a call and the telephone number of the phone terminal used for the call in a voice data storage unit so as to correspond to each other; storing user identification information, which identifies telephone numbers of phone terminals or users of the phone terminals, in an address storage unit so as to correspond to the email addresses of the users; storing user identification information, which identifies the users, in a user information storage unit so as to correspond to the telephone number; receiving the user identification information of any of the users by a computer; reading the telephone number corresponding to the received user identification information from the user information storage unit by the computer; acquiring information, which specifies the voice data corresponding to the telephone number, from the voice data storage unit by the computer; reading an email address, which corresponds to the received user identification information or the telephone number, from the address storage unit by the computer; and transmitting the acquired information which specifies the voice data, as an email, to the email address by the computer.

According to the present invention, there is provided a call information providing method comprising: storing voice data indicating the content of a call and the telephone number of the phone terminal used for the call in a voice data storage unit so as to correspond to each other; storing telephone numbers of the phone terminals in an address storage unit so as to correspond to the email addresses of users of the phone terminals; receiving the email address of any of the users by a computer; reading the telephone number corresponding to the received email address from the address storage unit by the computer; acquiring information, which specifies the voice data corresponding to the telephone number, from the voice data storage unit by the computer; and transmitting the acquired information which specifies the voice data, as an email, to the received email address by the computer.

According to the present invention, there is provided a call information providing method comprising: storing voice data indicating content of a call and the telephone number of the phone terminal used for the call in a voice data storage unit so as to correspond to each other; storing telephone numbers of phone terminals in an address storage unit so as to correspond to the email addresses of users of the phone terminals; acquiring from the voice data storage unit, information which specifies the new voice data and the telephone number corresponding to the new voice data by a computer, when the voice data storage unit has stored the new voice data; reading the email address, which corresponds to the telephone number acquired from the voice data storage unit, from the address storage unit by the computer; and transmitting the information which specifies the new voice data acquired by the voice data acquisition unit, as an email, to the email address by the computer.

According to the present invention, there is provided a program causing a computer to function as a call information providing device, and the program causes the computer, which is connectable to a voice data storage unit which stores voice data indicating content of a call and the telephone number of the phone terminal used for the call so as to correspond to each other, to realize: a function of storing user identification information, which identifies telephone numbers of phone terminals or users of the phone terminals, so as to correspond to the email addresses of the users; a function of storing user identification information, which identifies the users, so as to correspond to the telephone numbers; a function of receiving the user identification information of any of the users; a function of reading the telephone number corresponding to the received user identification information; a function of acquiring, from the voice data storage unit, information which specifies the voice data corresponding to the telephone number; a function of reading an email address corresponding to the received user identification information or the telephone number; and a function of transmitting the information which specifies the voice data acquired from the voice data storage unit, as an email, to the email address.

According to the present invention, there is provided a program causing a computer to function as a call information providing device, and the program causes the computer, which is connectable to a voice data storage unit which stores voice data indicating content of a call and a telephone number of a phone terminal used for a call so as to correspond to each other, to realize: a function of storing telephone numbers of phone terminals so as to correspond to email addresses of users of the phone terminals; a function of receiving the email address of any of the users; a function of reading the telephone number corresponding to the received email address; a function of acquiring, from the voice data storage unit, information which specifies the voice data corresponding to the telephone number; and a function of transmitting the information which specifies the voice data acquired from the voice data storage unit, as an email, to the received email address.

According to the present invention, there is provided a program causing a computer to function as a call information providing device, and the program causes the computer, which is connectable to a voice data storage unit which stores voice data indicating content of a call and the telephone number of the phone terminal used for the call so as to correspond to each other, to realize: a function of storing telephone numbers of phone terminals so as to correspond to the email addresses of users of the phone terminals; a function of acquiring from the voice data storage unit, information which specifies the new voice data and the telephone number corresponding to the new voice data, when the voice data storage unit has stored the new voice data; a function of reading the email address corresponding to the telephone number acquired from the voice data storage unit; and a function of transmitting the information which specifies the new voice data acquired by the voice data acquisition unit, as an email, to the email address.

According to the present invention, the content of a phone call and the content transmitted and received by email can be uniformly managed.

### BRIEF DESCRIPTION OF THE DRAWINGS

FIG. 1 is a view showing the configuration of a call information providing system according to a first embodiment.

FIG. 2 is a block diagram showing the functional configuration of a call information providing device.

FIG. 3 is a view showing the information stored in a user information storage unit in a table format.

FIG. 4 is a view showing the information stored in an address storage unit in a table format.

FIG. 5 is a view showing the information stored in a transmission source information storage unit in a table format.

FIG. 6 is a view showing the information stored in an email storage unit in a table format.

FIG. 7 is a block diagram showing the functional configuration of a voice data storage device.

FIG. 8 is a view showing the information stored in a voice data storage unit in a table format.

FIG. 9 is a flow chart showing an operation of the call information providing system.

FIG. 10 is a view showing a first example of the data structure of an email transmitted from an email transmission unit of the call information providing device.

FIG. 11 is a view showing a second example of the data structure of an email transmitted from the email transmission unit of the call information providing device.

FIG. 12 is a view showing the information stored in a user information storage unit according to a second embodiment in a table format.

FIG. 13 is a block diagram showing the functional configuration of a call information providing device according to a third embodiment.

FIG. 14 is a block diagram showing the functional configuration of a call information providing device according to a fourth embodiment.

FIG. 15 is a view showing the data configuration of information stored in a transmitted voice data storage unit in a table format.

FIG. 16 is a flow chart showing an operation of the call information providing system.

FIG. 17 is a block diagram showing the functional configuration of a call information providing device according to a fifth embodiment.

FIG. 18 is a flow chart showing an operation of the call information providing system.

FIG. 19 is a view showing the configuration of a call information providing system according to a sixth embodiment.

### BEST MODE FOR CARRYING OUT THE INVENTION

Hereinafter, embodiments of the present invention will be described with reference to the drawings. In addition, the same components are denoted by the same reference numerals in all drawings, and the explanation will not be repeated.

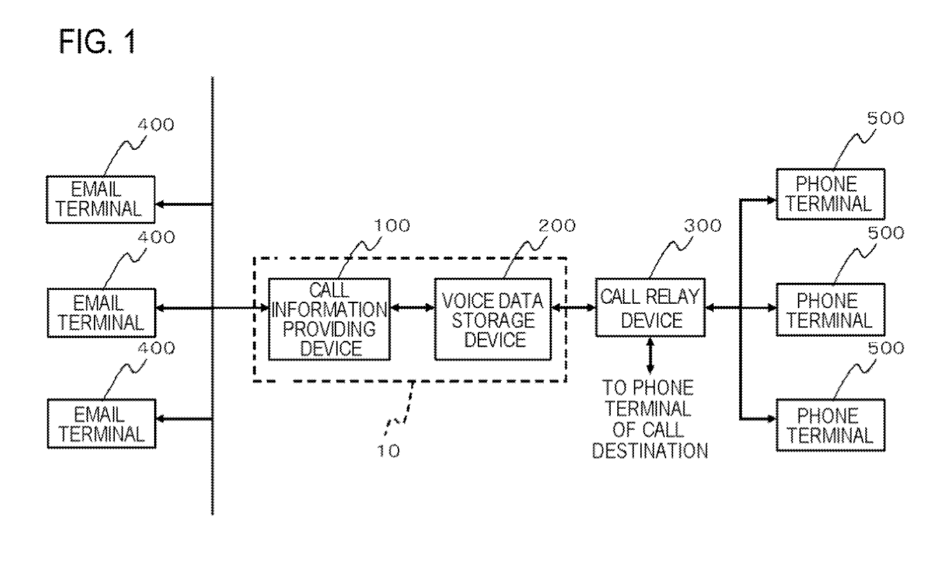

FIG. 1 is a view showing the configuration of a call information providing system 10 according to a first embodiment.

The call information providing system 10 includes a voice data storage device 200 and a call information providing device 100. The voice data storage device 200 stores voice data indicating the content of a call and the telephone number of a phone terminal 500 used for a call so as to correspond to each other. The call information providing device 100 transmits the information (or voice data itself), which specifies the voice data stored in the voice data storage device 200, to the email address of a user of the phone terminal 500 used for the call by email. Accordingly, the content of the call and the email can be uniformly managed by the emailer of an email terminal 400.

POP3 (RFC1939) or IMAP4 (RFC2060) may be used as an email protocol. In this case, the call information providing device 100 functions as a POP3 server or an IMAP server, and the email terminal 400 functions as a client.

In addition, the voice data storage device 200 acquires a call voice and a telephone number from a call relay device 300. The call relay device 300 performs relay processing between the phone terminal 500 and a phone terminal of a call destination. In addition, when a new call starts and ends thereafter, the voice data indicating the content of the call, telephone numbers of the phone terminal 500 used for the call and the call partner, call start time, and call end time are transmitted to the voice data storage device 200. In addition, the voice data storage device 200 stores various kinds of information received from the call relay device 300 so as to correspond to each other.

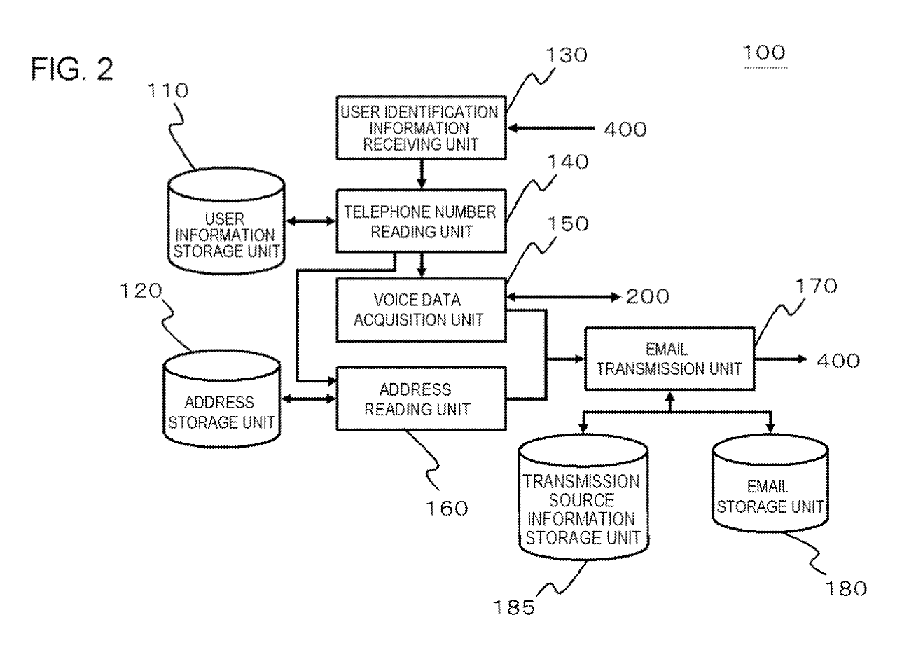

FIG. 2 is a block diagram showing the functional configuration of the call information providing device 100. The call information providing device 100 includes a user information storage unit 110, an address storage unit 120, a user identification information receiving unit 130, a telephone number reading unit 140, a voice data acquisition unit 150, an address reading unit 160, and an email transmission unit 170. The user information storage unit 110 stores the user identification information for identifying a user so as to correspond to the telephone number. The address storage unit 120 stores the user identification information or the telephone number of the phone terminal 500 so as to correspond to the email address of the user of the phone terminal 500. The user identification information receiving unit 130 receives the user identification information of any users. The telephone number reading unit 140 reads the telephone number, which corresponds to the user identification information received by the user identification information receiving unit 130, from the user information storage unit 110. The voice data acquisition unit 150 acquires the information, which specifies the voice data corresponding to the telephone number read by the telephone number reading unit 140, from the voice data storage device 200. The address reading unit 160 reads from the address storage unit 120, the user identification information received by the user identification information receiving unit 130 or the email address corresponding to the telephone number read by the telephone number reading unit 140. The email transmission unit 170 transmits the information, which specifies the voice data acquired by the voice data acquisition unit 150, as an email, to the email address read by the address reading unit 160.

In addition, the voice data acquisition unit 150 receives the telephone number of the calling side and the telephone number of the call receiving side in a call corresponding to the voice data as well as the voice data. Either the telephone number of the calling side or the telephone number of the call receiving side is the telephone number of a call partner of the user of the phone terminal 500. In addition, the call information providing device 100 includes a transmission source information storage unit 185. The transmission source information storage unit 185 stores the telephone number of the call partner described above and the attribution information (for example, name), which indicates an attribute of the call partner, so as to correspond to each other. In addition, the email transmission unit 170 includes the attribution information of the call partner in the email to be transmitted.

In addition, the call information providing device 100 further includes an email storage unit 180. The email storage unit 180 stores an email transmitted from the email transmission unit 170 every user.

In addition, the configuration of units which are not relevant to the essence of the present invention is not shown in FIG. 2.

Each component of the call information providing device 100 shown in FIG. 2 does not indicate the configuration of a hardware unit but indicates a block of a functional unit.

Each component of the call information providing device 100 is realized by any combination of hardware and software based on a CPU of any computer, a memory, a program loaded in the memory for realizing the components in the drawing, a storage unit such as a hard disk which stores the program, and an interface for network connection. In addition, it will be understood by those skilled in the art that there are various modifications of the realization method and the apparatus.

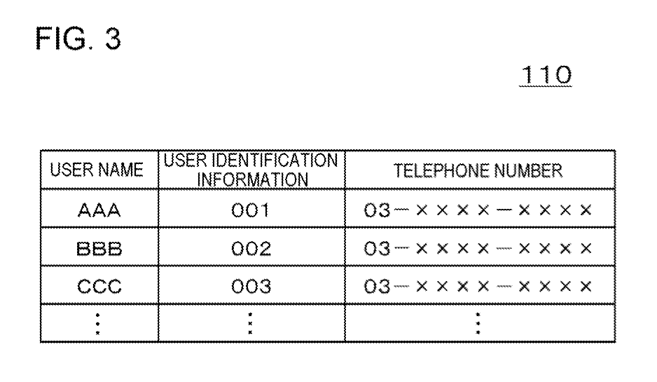

FIG. 3 is a view showing the information stored in the user information storage unit 110 in a table format. The user information storage unit 110 stores the user identification information and the telephone number of the phone terminal 500 that the user uses so as to correspond to the user name.

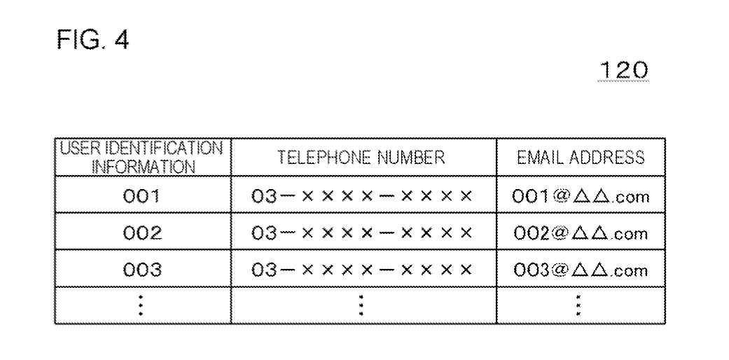

FIG. 4 is a view showing the information stored in the address storage unit 120 in a table format. For each item of the user identification information, the address storage unit 120 stores the telephone number of the phone terminal 500, which the user corresponding to the user identification information uses, and the email address of the user so as to correspond to each other.

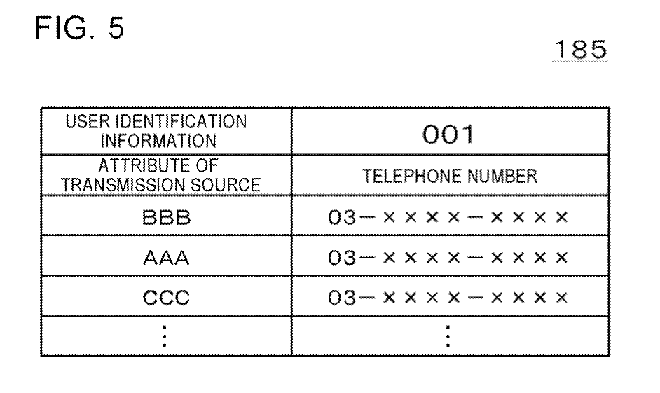

FIG. 5 is a view showing the information stored in the transmission source information storage unit 185 in a table format. For each item of the user identification information of the phone terminal 500, the transmission source information storage unit 185 stores an attribute (that is, an attribute of a transmission source) of a person, who can be a call partner, and the telephone number of a phone terminal of the person so as to correspond to each other. The attribute of the person who can be a call partner includes the person's name or affiliation, for example. This attribute is set by a user, for example.

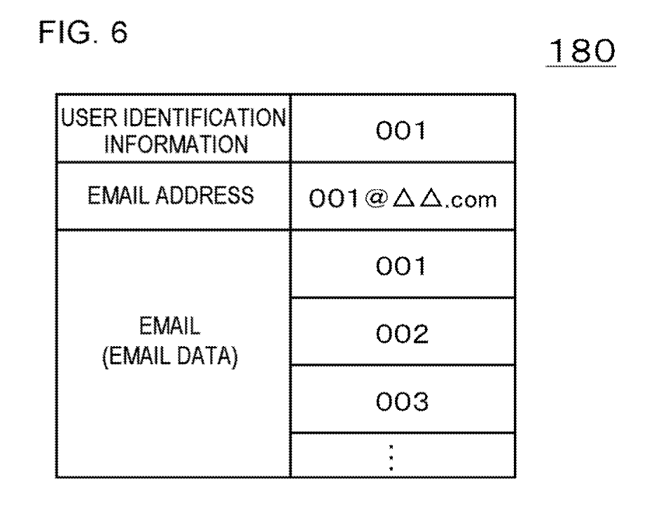

FIG. 6 is a view showing the information stored in the email storage unit 180 in a table format. For each item of the user identification information, the email storage unit 180 stores an email address corresponding to the user identification information and the email data of an email transmitted to the email address by the email transmission unit 170. Accordingly, the email transmission unit 170 can check an email already transmitted by referring to the email storage unit 180. In addition, details of the data structure of an email will be described later.

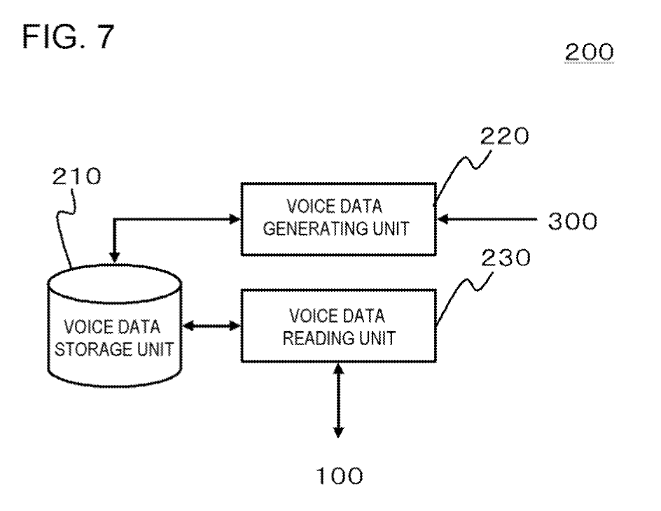

FIG. 7 is a block diagram showing the functional configuration of the voice data storage device 200. The voice data storage device 200 includes a voice data storage unit 210, a voice data generating unit 220, and a voice data reading unit 230. The voice data storage unit 210 stores the voice data indicating the content of a call so as to correspond to the telephone number of the phone terminal 500 used for the call. The voice data generating unit 220 acquires the voice of a call and the telephone number of the phone terminal 500 from the call relay device 300 and converts the voice of the call into the voice data, and then stores the voice data after conversion in the voice data storage unit 210 so as to correspond to the telephone number of the phone terminal 500. The voice data reading unit 230 receives the telephone number from the voice data acquisition unit 150 of the call information providing device 100, reads the voice data corresponding to the telephone number from the voice data storage unit 210, and transmits it to the voice data acquisition unit 150.

In addition, the voice data storage device 200 stores the voice data of all calls in all phone terminals 500.

In addition, the configuration of units which are not relevant to the essence of the present invention is not shown in FIG. 7. Each component of the voice data storage device 200 shown in FIG. 7 does not indicate the configuration of a hardware unit but indicates a block of a functional unit. Each component of the voice data storage device 200 is realized by any combination of hardware and software based on a CPU of any computer, a memory, a program loaded in the memory for realizing the components in the drawing, a storage unit such as a hard disk which stores the program, and an interface for network connection. In addition, it will be understood by those skilled in the art that there are various modifications of the realization method and the apparatus.

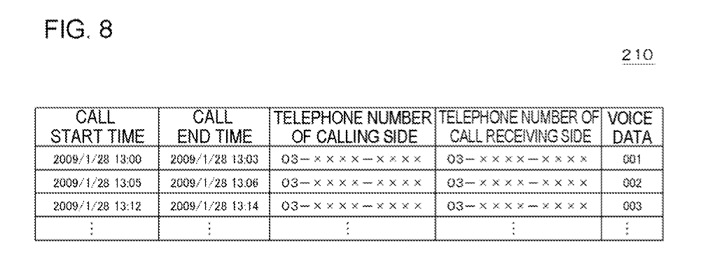

FIG. 8 is a view showing the information stored in the voice data storage unit 210 in a table format. The voice data storage unit 210 stores the voice data indicating the content of a call, start time and end time of the call, the telephone number of the calling side, and the telephone number of the call receiving side so as to correspond to each other. In addition, the voice data reading unit 230 reads the voice data, which includes the telephone number acquired from the voice data acquisition unit 150 into either the telephone number of the calling side or the telephone number of the call receiving side, from the voice data storage unit 210.

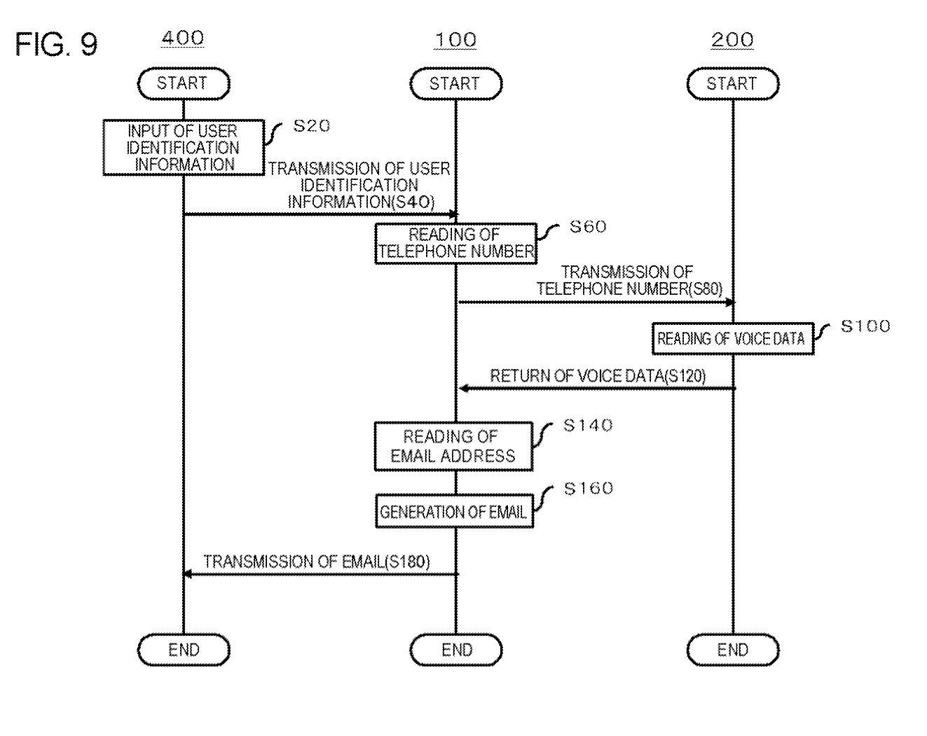

FIG. 9 is a flow chart showing an operation of the call information providing system 10. Firstly, when starting the email terminal 400 or when starting the email software of the email terminal 400, a user inputs login information into the email terminal 400. The login information includes the user identification information (step S20). The email terminal 400 transmits the input user identification information to the call information providing device 100 (step S40).

The user identification information receiving unit 130 of the call information providing device 100 receives the user identification information from the email terminal 400 and transmits the received user identification information to the telephone number reading unit 140. The telephone number reading unit 140 reads the telephone number, which corresponds to the user identification information transmitted from the user identification information receiving unit 130, from the user information storage unit 110, and transmits the telephone number to the voice data acquisition unit 150 and the address reading unit 160 (step S60).

The voice data acquisition unit 150 transmits the transmitted telephone number to the voice data storage device 200 (step S80).

The voice data reading unit 230 of the voice data storage device 200 reads the voice data, which includes the telephone number transmitted from the voice data acquisition unit 150 of the call information providing device 100 into either the telephone number of the calling side or the telephone number of the call receiving side, together with the telephone number of the transmission side of the voice data, the telephone number of the receiving side, and the call start time and the call end time (step S100). In addition, the voice data reading unit 230 transmits the voice data to the voice data acquisition unit 150 of the call information providing device 100 so as to correspond to the telephone number of the transmission side, the telephone number of the receiving side, and the call start time and end time (step S120).

The voice data acquisition unit 150 transmits the received voice data and the call start time and end time to the email transmission unit 170 of the call information providing device 100. In addition, the voice data acquisition unit 150 determines the telephone number which is not the telephone number read by the telephone number reading unit 140, of the telephone number of the transmission side and the telephone number of the receiving side, as the telephone number of the call partner, and transmits it to the email transmission unit 170.

On the other hand, the address reading unit 160 of the call information providing device 100 reads the email address, which corresponds to the telephone number transmitted from the telephone number reading unit 140, from the address storage unit 120, and transmits the email address to the email transmission unit 170 (step S140).

The email transmission unit 170 of the call information providing device 100 generates an email transmitted to the email terminal 400 by using the telephone number of the transmission side, the telephone number of the receiving side, and the call start time and end time, each of which is transmitted from the voice data acquisition unit 150 (step S160).

In this email, the voice data is attached to the email. In addition, either the call start time or the call end time is used as a transmission time of an email. In addition, the email address read by the address reading unit 160 is used as an address of the transmission destination of the email. In addition, the email transmission unit 170 reads an attribute corresponding to the telephone number of the call partner from the transmission source information storage unit 185, and sets the attribute to the transmission source of the email.

Then, the email transmission unit 170 transmits the email generated in step S160 to the email terminal 400 (step S180). In addition, the email transmission unit 170 stores the transmitted email in the email storage unit 180.

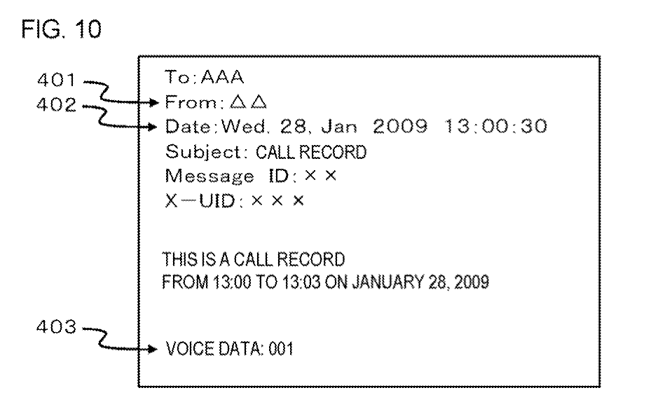

FIG. 10 is a view showing a first example of the data structure of an email transmitted from the email transmission unit 170 of the call information providing device 100. In this email, the attribute read from the transmission source information storage unit 185 by the email transmission unit 170 is written in a transmission source column 401. In addition, the start time or end time of a call is written in a transmission time column 402, not the time at which an email was actually transmitted. In addition, voice data 403 is attached to the email.

In addition, the email transmitted from the email transmission unit 170 includes a message ID and X-UID. In addition, text indicating the start time and the end time of a call is written in the body text.

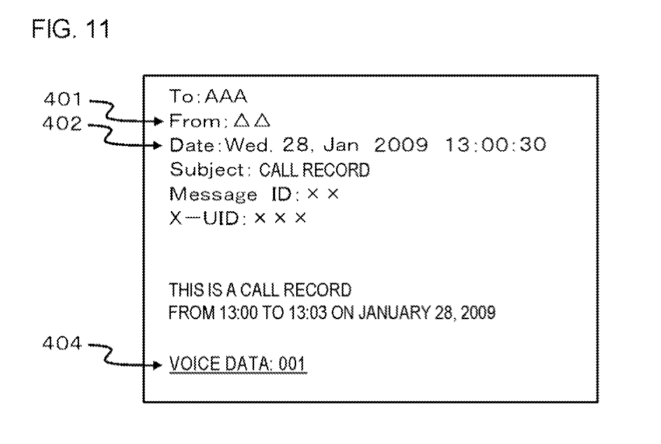

FIG. 11 is a view showing a second example of the data structure of an email transmitted from the email transmission unit 170 of the call information providing device 100. This email is the same as that in the first example shown in FIG. 10 except that link information 404 indicating a link to voice data is attached instead of attaching the voice data.

That is, in this example, link information to the voice data (information which specifies the voice data) is generated instead of reading the voice data in step S100 of FIG. 9. In addition, this link information is transmitted in step S120. In addition, the link information 404 to the voice data is used, as information which specifies the voice data, in the email generated in step S160.

In addition, when a user of the email terminal 400 selects the link information 404, the email terminal 400 accesses the voice data storage device 200 and acquires the voice data, designated by the link information 404, from the voice data storage device 200.

As described above, according to the present embodiment, the call information providing device 100 transmits the information (or voice data itself), which specifies the voice data stored in the voice data storage device 200, to the email address of the user of the phone terminal 500 used for the call by email. Accordingly, the content of the call and the email can be uniformly managed by the emailer of the email terminal 400. This effect becomes noticeable especially when the voice data storage device 200 stores the voice data of all calls in all phone terminals 500.

In addition, the transmission time of an email which is transmitted is not the time at which the email was actually transmitted but the start time or end time of a call. Therefore, emails and calls can be uniformly managed in time series by managing the emails in time series using email software.

Moreover, in the present embodiment, the telephone number reading unit 140 may read the telephone number from the address storage unit 120 instead of the user information storage unit 110. In addition, the address reading unit 160 may acquire the user identification information from the telephone number reading unit 140, and read the email address corresponding to the user identification information from the address storage unit 120.

In addition, using telephone book data as the address storage unit 120 may be considered. Generally, the telephone book data is set in units of user identification information or set in a system unit. In such a case, in the telephone book data used as the address storage unit 120, the telephone book data set in the user unit is given priority. In addition, when there is no data required for the telephone book data set in the user unit, the telephone book data set in the system unit is used as the address storage unit 120.

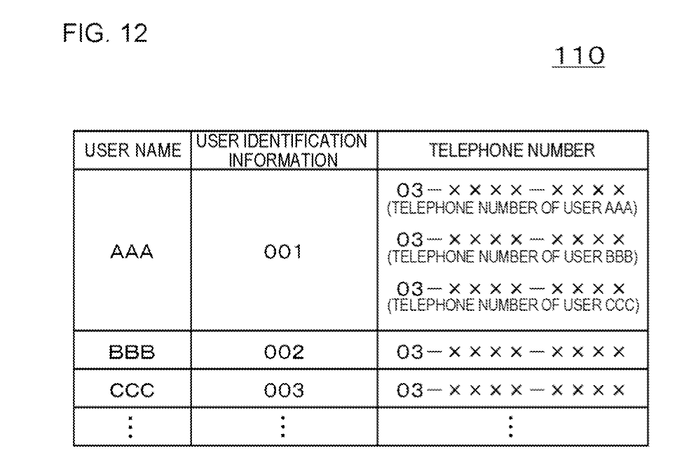

FIG. 12 is a view showing the information, which is stored in the user information storage unit 110 according to a second embodiment, in a table format. The call information providing system 10 according to the present embodiment has the same configuration as that of the call information providing system 10 according to the first embodiment except for the following.

First, as shown in FIG. 12, the user information storage unit 110 of the call information providing device 100 stores the telephone number of the phone terminal 500, which a user specified by the user identification information uses, and the telephone number of the phone terminal 500, which another user (for example, a subordinate) uses, so as to correspond to the user identification information.

In addition, the telephone number reading unit 140 of the call information providing device 100 reads all telephone numbers corresponding to the user identification information, which the user identification information receiving unit 130 has received, and transmits them to the voice data acquisition unit 150. In addition, the voice data acquisition unit 150 and the email transmission unit 170 perform the processing shown in the first embodiment for all of the transmitted telephone numbers.

According to the present embodiment, the same effects as in the first embodiment also can be achieved. In addition, when it is necessary to manage calls of other people, the content of the calls can also be uniformly managed by email software.

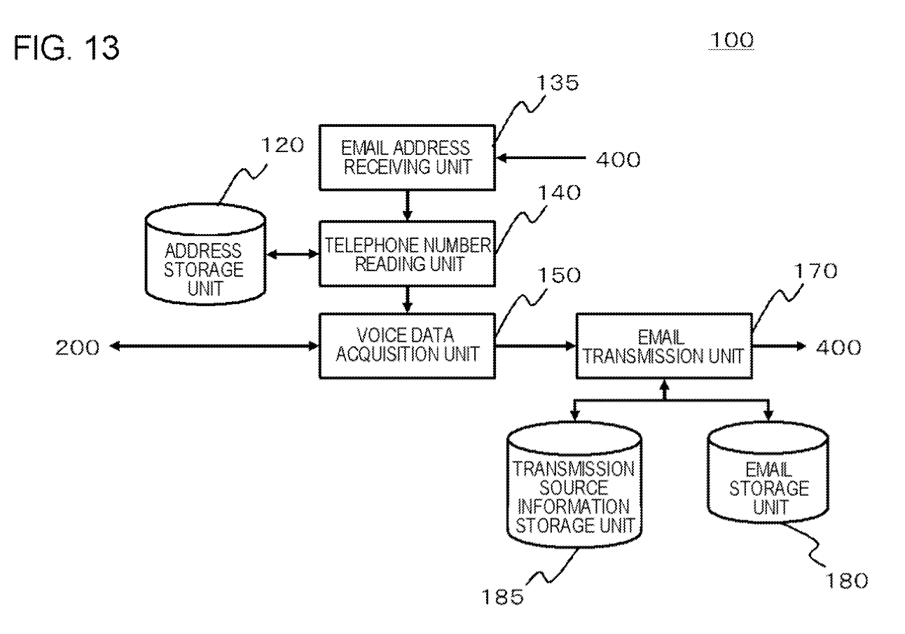

FIG. 13 is a block diagram showing the functional configuration of a call information providing device 100 according to a third embodiment. This call information providing device 100 receives an email address from the email terminal 400 instead of the user identification information, and performs acquisition processing and transmission processing of the voice data on the basis of the email address.

Specifically, the call information providing device 100 shown in this drawing includes an address storage unit 120, an email address receiving unit 135, a telephone number reading unit 140, a voice data acquisition unit 150, an email transmission unit 170, an email storage unit 180, and a transmission source information storage unit 185. The data configuration of the -address storage unit 120, the email storage unit 180 and the transmission source information storage unit 185, and the functional configuration of the email transmission unit 170 are the same as those in the first embodiment.

The email address receiving unit 135 receives the email address of any users from the email terminal 900. In addition, the telephone number reading unit 140 reads the telephone number corresponding to the email address received by the email address receiving unit 135, from the address storage unit 120, and transmits it to the voice data acquisition unit 150 together with the email address.

In addition to the function shown in the first embodiment, the voice data acquisition unit 150 transmits the email address transmitted from the telephone number reading unit 140 to the email transmission unit 170 so as to correspond to the voice data.

The email transmission unit 170 transmits an email to the email address transmitted from the voice data acquisition unit 150.

In addition, other configurations and operations of the call information providing system 10 are the same as those in the first embodiment.

According to the present embodiment, the same effects as in the first embodiment also can be achieved.

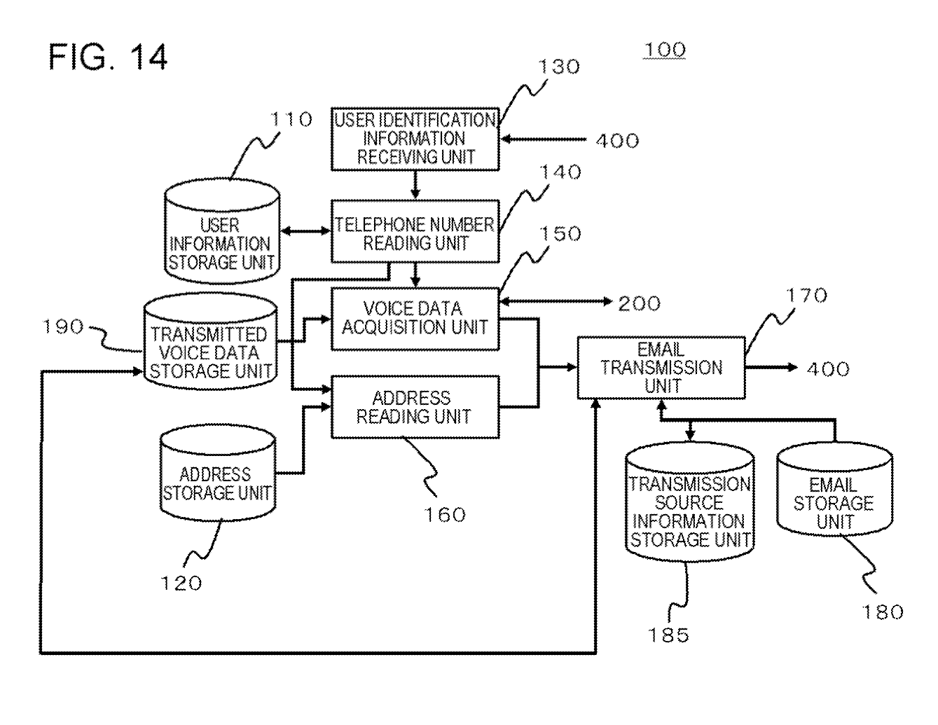

FIG. 14 is a block diagram showing the functional configuration of a call information providing device 100 according to a fourth embodiment. This call information providing device 100 has the same configuration as that of the call information providing device 100 according to the first embodiment except that a transmitted voice data storage unit 190 is provided.

The transmitted voice data storage unit 190 stores at least the information which specifies a call time of the voice data having the latest call time, among items of the information which specifies the voice data transmitted by the email transmission unit 170, for each user. In addition, either the voice data acquisition unit 150 or the email transmission unit 170 performs processing for specifying the non-transmitted voice data on the basis of the information stored in the transmitted voice data storage unit 190. In the example shown in FIG. 14, the voice data acquisition unit 150 performs this processing.

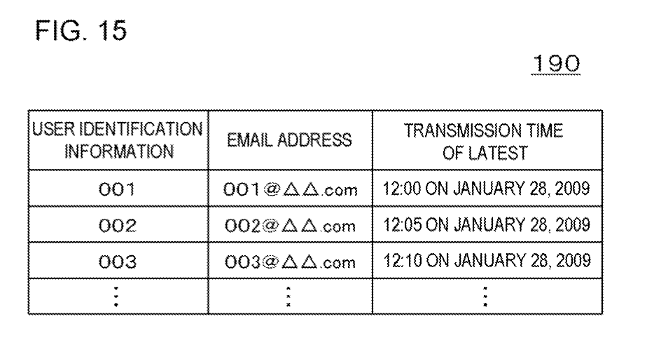

FIG. 15 is a view showing the data configuration of the information stored in the transmitted voice data storage unit 190 in a table format. For each item of the user identification information, the transmitted voice data storage unit 190 stores the email address of a user corresponding to the user identification information, and the information (transmission time) which specifies a call time of the voice data having the latest call time.

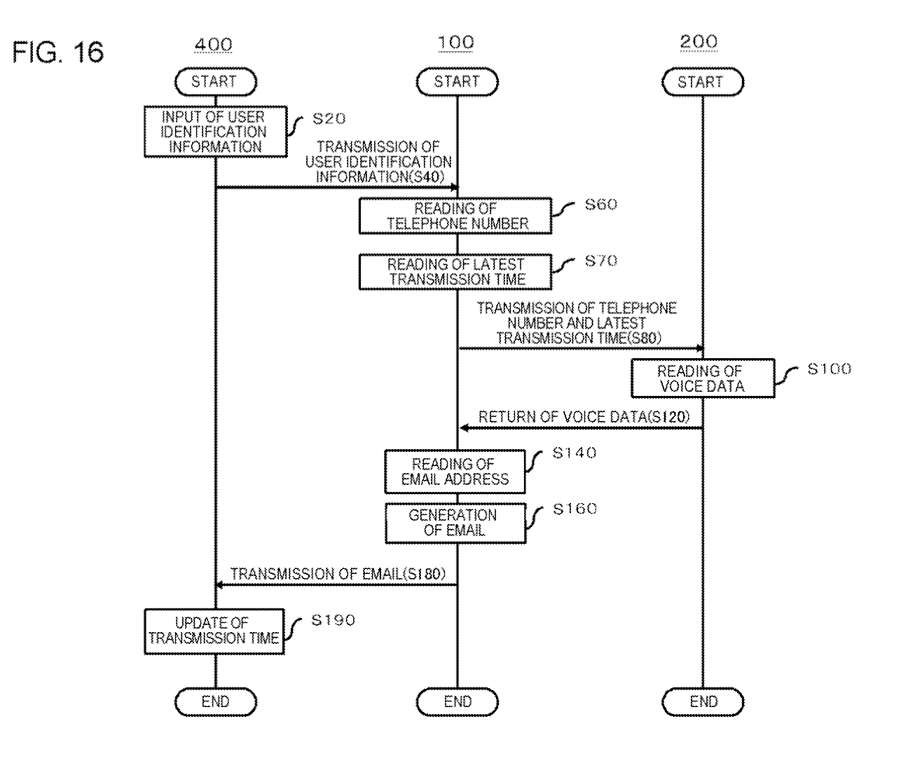

FIG. 16 is a flow chart showing an operation of the call information providing system 10 according to the present embodiment. The processing shown in this drawing is the same as the operation described using FIG. 9 in the first embodiment except for the following points.

Firstly, after transmitting an email (step S180), the email transmission unit 170 stores the time used as the transmission time of the email (that is, the call time of a call as the origin of voice data) in the transmitted voice data storage unit 190 so as to correspond to the user identification information corresponding to the email address of the transmission destination (step S190).

Moreover, in step S60, the telephone number reading unit 140 transmits the user identification information together with the telephone number.

Then, the voice data acquisition unit 150 reads the latest transmission time, which corresponds to the user identification information acquired from the telephone number reading unit 140, from the transmitted voice data storage unit 190 between steps S60 and S80 (step S70). Then, in step S80, the voice data acquisition unit 150 transmits the transmission time and the telephone number read by the telephone number reading unit 140 to the voice data storage device 200.

Then, in step S100, the voice data storage device 200 reads voice data, which includes the telephone number received from the call information providing device 100 into the telephone number of the transmission side or the telephone number of the receiving side, among the voice data having a call start time which is newer than the transmission time received from the call information providing device 100.

According to the present embodiment, the same effects as in the first embodiment also can be achieved. In addition, double transmission of the voice data to the email terminal 400 can be suppressed.

Moreover, in the second or third embodiment, the transmitted voice data storage unit 190 may be provided as in the present embodiment to perform the processing as in the present embodiment.

Next, the call information providing system 10 according to a fifth embodiment will be described. This call information providing system 10 has the same configuration as that of the call information providing system 10 according to the first embodiment except for a transmission timing of the voice data from the voice data storage device 200 to the call information providing device 100.

The voice data storage device 200 according to the present embodiment is the same as that in the first embodiment except that the timing at which the voice data reading unit 230 transmits the voice data to the call information providing device 100 is not when the telephone number is transmitted from the call information providing device 100, but when new voice data is stored.

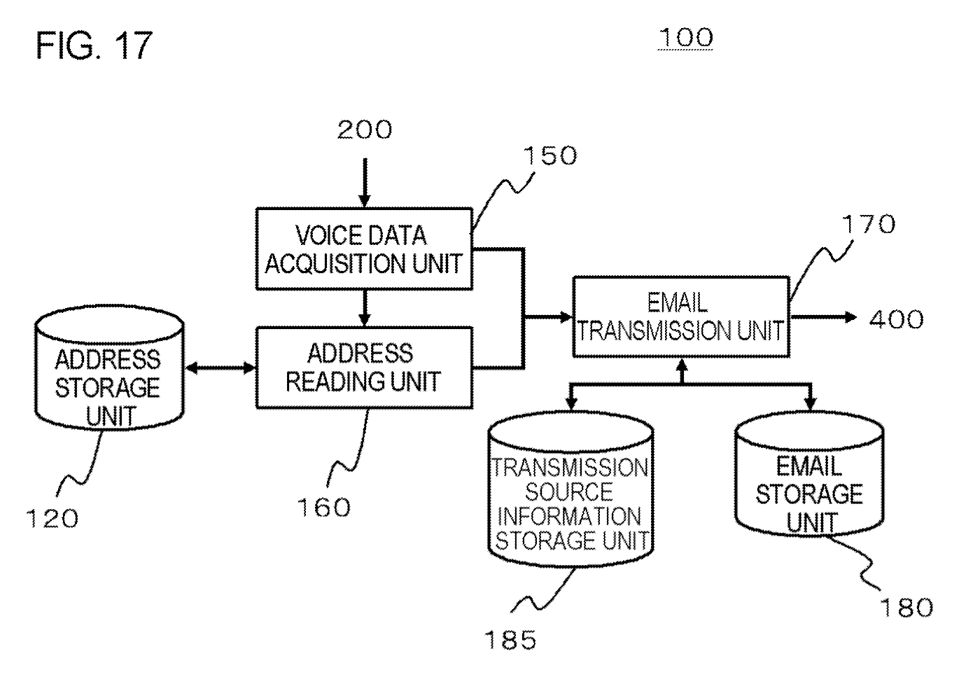

FIG. 17 is a block diagram showing the functional configuration of the call information providing device 100 according to the present embodiment. In the present embodiment, the call information providing device 100 includes an address storage unit 120, a voice data acquisition unit 150, an address reading unit 160, an email transmission unit 170, an email storage unit 180, and a transmission source information storage unit 185. The data configuration of the address storage unit 120 and the function of the email transmission unit 170 are the same as those in the first embodiment.

When the voice data storage device 200 stores new voice data, the voice data acquisition unit 150 acquires the information, which specifies the new voice data and the telephone number corresponding to the new voice data, from the voice data storage device 200. The address reading unit 160 reads the email address, which corresponds to the telephone number acquired by the voice data acquisition unit 150, from the address storage unit 120.

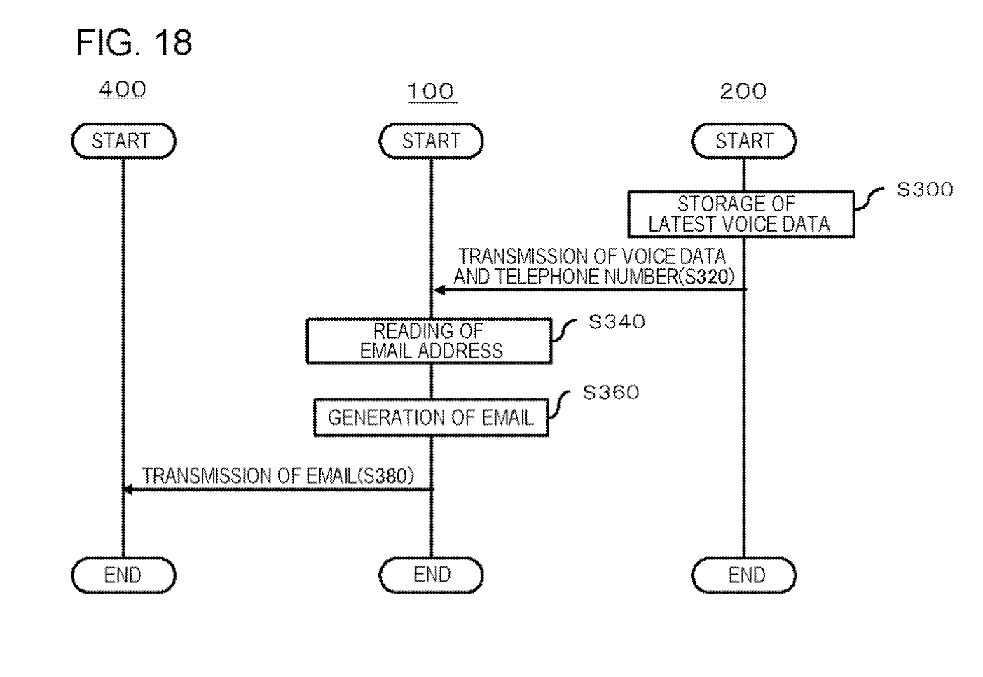

FIG. 18 is a flow chart showing an operation of the call information providing system 10 according to the present embodiment. The voice data generating unit 220 of the voice data storage device 200 stores the voice data of a new call, the start time and the end time of the call, the telephone number of the calling side, and the telephone number of the call receiving side in the voice data storage unit 210 (step S300). Then, the voice data reading unit 230 of the voice data storage device 200 reads from the voice data storage unit 210, the voice data newly stored in the voice data storage unit 210, the start time and the end time corresponding to the voice data, the telephone number of the calling side and the telephone number of the call receiving side, and transmits them to the voice data acquisition unit 150 of the call information providing device 100 (step S320).

The voice data acquisition unit 150 of the call information providing device 100 transmits the acquired voice data, the start time, and the end time to the email transmission unit 170. In addition, the voice data acquisition unit 150 transmits the acquired telephone number of the calling side and the acquired telephone number of the call receiving side to the address reading unit 160.

The address reading unit 160 checks which of the telephone numbers of the calling side and the call receiving side is stored in the address storage unit 120. In addition, the address reading unit 160 determines the stored telephone number as a telephone number of the phone terminal 500, while determining the telephone number, which is not stored, as a telephone number of a call partner of the user of the phone terminal 500. The address reading unit 160 reads an email address, which corresponds to the telephone number determined as the telephone number of the phone terminal 500, from the address storage unit 120, and transmits it to the email transmission unit 170. In addition, the address reading unit 160 transmits to the email transmission unit 170, the telephone number determined as the telephone number of the call partner (step S340).

In addition, the email transmission unit 170 generates an email (step S360) and transmits the email (step S380). Since these processes are the same as those in steps S160 and S180 in the first embodiment, the explanation will not be repeated.

In the present embodiment, the IDLE command of IMAP specified by RFC2177 and SMTP specified by RFC821 may be used as the email protocol in step S380.

According to the present embodiment, the same effects as in the first embodiment also can be achieved. In addition, the information which specifies the voice data may not be included in the email generated in step S360. In this case, the email in S360 and S380 becomes the content for notifying a user of the user terminal 400 that there is new voice data. In addition, the process to request the voice data from the user terminal 400 is performed after step S380. Then, the call information providing device 100 transmits the information, which specifies the voice data, to the user terminal 400.

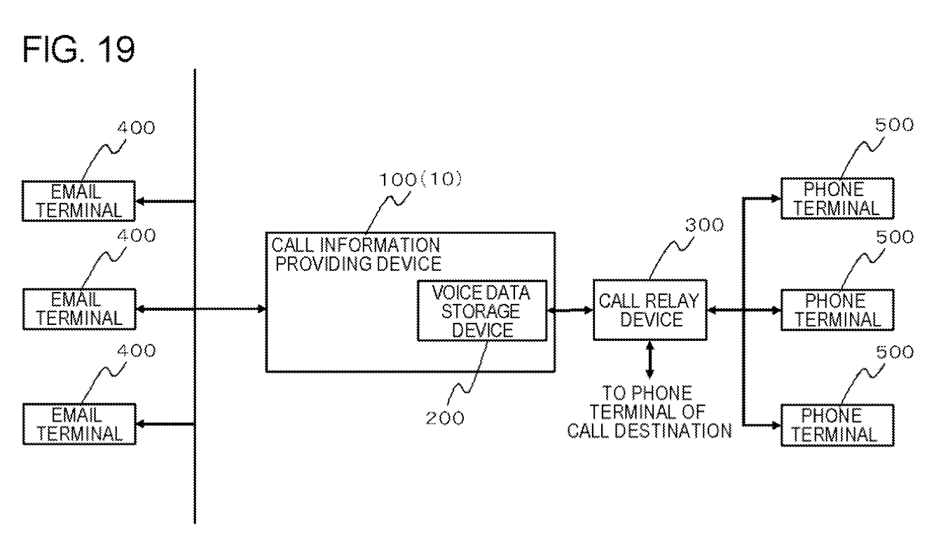

FIG. 19 is a view showing the configuration of the call information providing system 10 according to a sixth embodiment, and is a view equivalent to FIG. 1 in the first embodiment. This call information providing system 10 is the same as that in any of the first to fifth embodiments except that the call information providing device 100 has a function of the voice data storage device 200. According to the present invention, the same effects as in the first to fifth embodiments also can be achieved.

While the embodiments of the present invention have been described with reference to the drawings, these are only illustrative of the present invention, and other various configurations may also be adopted.

This application claims priority from Japanese Patent Application No. 2009-028671, filed on Feb. 10, 2009, the entire content of which is incorporated herein.

1. A call information providing device comprising:
an address storage unit which stores user identification information, which identifies telephone numbers of phone terminals or users of the phone terminals, so as to correspond to email addresses of the users;
a user information storage unit which stores user identification information, which identifies the users, correspond to the telephone numbers;
a user identification information receiving unit which receives the user identification information of any of the users;
a telephone number reading unit which reads the telephone number, which corresponds to the user identification information received by the user identification information receiving unit, from the user information storage unit;
a voice data acquisition unit which acquires, from a voice data storage unit which stores voice data indicating content of a call and a telephone number of the phone terminal used for a call so as to correspond to each other, information which specifies the voice data corresponding to the telephone number read by the telephone number reading unit;
an address reading unit which reads an email address, which corresponds to the user identification information received by the user identification information receiving unit or the telephone number read by the telephone number reading unit, from the address storage unit; and
an email transmission unit which transmits the information which specifies the voice data acquired by the voice data acquisition unit, as an email, to the email address read by the address reading unit.

2. The call information providing device according to claim 1,
wherein the user information storage unit stores the telephone number of the phone terminal, which the user specified by the user identification information uses, and the telephone numbers of the phone terminals, which other users use, so as to correspond to the user identification information, and
the telephone number reading unit reads all of the telephone numbers corresponding to the user identification information.

3. A call information providing device comprising:
an address storage unit which stores telephone numbers of phone terminals so as to correspond to email addresses of users of the phone terminals;
an email address receiving unit which receives the email address of any of the users;
a telephone number reading unit which reads the telephone number, which corresponds to the email address received by the email address receiving unit, from the address storage unit;
a voice data acquisition unit which is connectable to a voice data storage unit, which stores voice data indicating content of a call and a telephone number of the phone terminal used for a call so as to correspond to each other, and which reads information, which specifies the voice data corresponding to the telephone number read by the telephone number reading unit, from the voice data storage unit; and
an email transmission unit which transmits the information which specifies the voice data read by the voice data acquisition unit, as an email, to the email address received by the email address receiving unit.

4. The call information providing device according to claim 1,
wherein the voice data storage unit further stores a call time of the voice data,
the voice data acquisition unit further reads the call time from the voice data storage unit, and
the email transmission unit uses the call time acquired by the voice data acquisition unit as a transmission time of the email.

5. The call information providing device according to claim 1,
wherein information which specifies the voice data transmitted from the email transmission unit by the email is the voice data itself.

6. The call information providing device according to claim 1,
wherein information which specifies the voice data transmitted from the email transmission unit by the email is link information indicating a link to the voice data.

7. The call information providing device according to claim 1,
wherein the voice data storage unit is provided outside the call information providing device.

8. The call information providing device according to claim 1, further comprising:
the voice data storage unit.

9. The call information providing device according to claim 8,
wherein the voice data storage unit stores the voice data of all calls in the phone terminal.

10. The call information providing device according to claim 1, further comprising:
a transmitted voice data storage unit which stores at least information which specifies a call time of the voice data having a latest call time, of the information which specifies the voice data transmitted from the email transmission unit, for each of the users, and
either the voice data acquisition unit or the email transmission unit performs processing for specifying the voice data, which has not yet been transmitted, on the basis of the information stored in the transmitted voice data storage unit.

11. A call information providing device comprising:
an address storage unit which stores telephone numbers of phone terminals so as to correspond to email addresses of users of the phone terminals;
a voice data acquisition unit which when a voice data storage unit, which stores voice data indicating content of a call and a telephone number of the phone terminal used for a call so as to correspond to each other, has stored the new voice data, acquires from the voice data storage unit, information which specifies the new voice data and the telephone number corresponding to the new voice data;
an address reading unit which reads the email address, which corresponds to the telephone number acquired by the voice data acquisition unit, from the address storage unit; and
an email transmission unit which transmits the information which specifies the new voice data acquired by the voice data acquisition unit, as an email, to the email address read by the address reading unit.

12. A call information providing system comprising:
a voice data storage device which stores voice data indicating content of a call and a telephone number of a phone terminal used for a call so as to correspond to each other; and
a call information providing device which transmits information which specifies the voice data by email,
wherein the call information providing device includes:
an address storage unit which stores user identification information, which identifies telephone numbers of phone terminals or users of the phone terminals, so as to correspond to email addresses of the users;
a user information storage unit which stores user identification information, which identifies the users, so as to correspond to the telephone numbers;
a user identification information receiving unit which receives the user identification information of any of the users;
a telephone number reading unit which reads the telephone number, which corresponds to the user identification information received by the user identification information receiving unit, from the user information storage unit;
a voice data acquisition unit which acquires, from the voice data storage device, information which specifies the voice data corresponding to the telephone number read by the telephone number reading unit;
an address reading unit which reads an email address, which corresponds to the user identification information received by the user identification information receiving unit or the telephone number read by the telephone number reading unit, from the address storage unit; and
an email transmission unit which transmits the information which specifies the voice data acquired by the voice data acquisition unit, as an email, to the email address read by the address reading unit.

13. A call information providing system comprising:
a voice data storage device which stores voice data indicating content of a call and a telephone number of a phone terminal used for a call so as to correspond to each other; and
a call information providing device which transmits information which specifies the voice data by email,
wherein the call information providing device includes:
an address storage unit which stores telephone numbers of phone terminals so as to correspond to email addresses of users of the phone terminals;
an email address receiving unit which receives the email address of any of the users;
a telephone number reading unit which reads the telephone number, which corresponds to the email address received by the email address receiving unit, from the address storage unit;
a voice data acquisition unit which acquires information, which specifies the voice data corresponding to the telephone number read by the telephone number reading unit, from the voice data storage unit; and
an email transmission unit which transmits the information which specifies the voice data acquired by the voice data acquisition unit, as an email, to the email address received by the email address receiving unit.

14. A call information providing system comprising:
a voice data storage device which stores voice data indicating content of a call and a telephone number of a phone terminal used for a call so as to correspond to each other; and
a call information providing device which transmits information which specifies the voice data by email,
wherein the voice data storage device includes a voice data reading unit which when the new voice data has been stored, transmits to the call information providing device, information which specifies the new voice data and the telephone number corresponding to the new voice data, and
the call information providing device includes:
an address storage unit which stores telephone numbers of phone terminals so as to correspond to email addresses of users of the phone terminals;
a voice data acquisition unit which acquires from the voice data storage device, information which specifies the new voice data and the telephone number corresponding to the new voice data;
an address reading unit which reads the email address, which corresponds to the telephone number acquired by the voice data acquisition unit, from the address storage unit; and
an email transmission unit which transmits the information which specifies the new voice data acquired by the voice data acquisition unit, as an email, to the email address read by the address reading unit.

15. A call information providing method comprising:
storing voice data indicating content of a call and a telephone number of a phone terminal used for a call in a voice data storage unit so as to correspond to each other;
storing user identification information, which identifies telephone numbers of phone terminals or users of the phone terminals, in an address storage unit so as to correspond to email addresses of the users;
storing user identification information, which identifies the users, in a user information storage unit so as to correspond to the telephone number;
receiving the user identification information of any of the users by a computer;
reading the telephone number corresponding to the received user identification information from the user information storage unit by the computer;
acquiring information, which specifies the voice data corresponding to the telephone number, from the voice data storage unit by the computer;
reading an email address, which corresponds to the received user identification information or the telephone number, from the address storage unit by the computer; and
transmitting the acquired information which specifies the voice data, as an email, to the email address by the computer.

16. A call information providing method comprising:
storing voice data indicating content of a call and a telephone number of a phone terminal used for a call in a voice data storage unit so as to correspond to each other;
storing telephone numbers of the phone terminals in an address storage unit so as to correspond to email addresses of users of the phone terminals;
receiving the email address of any of the users by a computer;
reading the telephone number corresponding to the received email address from the address storage unit by the computer;
acquiring information, which specifies the voice data corresponding to the telephone number, from the voice data storage unit by the computer; and
transmitting the acquired information which specifies the voice data, as an email, to the received email address by the computer.

17. A call information providing method comprising:
storing voice data indicating content of a call and a telephone number of a phone terminal used for a call in a voice data storage unit so as to correspond to each other;
storing telephone numbers of phone terminals in an address storage unit so as to correspond to email addresses of users of the phone terminals;
acquiring from the voice data storage unit, information which specifies the new voice data and the telephone number corresponding to the new voice data by a computer, when the voice data storage unit has stored the new voice data;
reading the email address, which corresponds to the telephone number acquired from the voice data storage unit, from the address storage unit by the computer; and
transmitting the information which specifies the new voice data acquired by the voice data acquisition unit, as an email, to the email address by the computer.

18. A computer readable media which records a program causing a computer to function as a call information providing device, the program causing the computer, connectable to a voice data storage unit which stores voice data indicating content of a call and a telephone number of a phone terminal used for a call so as to correspond to each other, to realize:
a function of storing user identification information, which identifies telephone numbers of phone terminals or users of the phone terminals, so as to correspond to email addresses of the users;
a function of storing user identification information, which identifies the users, so as to correspond to the telephone numbers;
a function of receiving the user identification information of any of the users;
a function of reading the telephone number corresponding to the received user identification information;
a function of acquiring, from the voice data storage unit, information which specifies the voice data corresponding to the telephone number;
a function of reading an email address corresponding to the received user identification information or the telephone number; and
a function of transmitting the information which specifies the voice data acquired from the voice data storage unit, as an email, to the email address.

19. A computer readable media which records a program causing a computer to function as a call information providing device, the program causing the computer, connectable to a voice data storage unit which stores voice data indicating content of a call and a telephone number of a phone terminal used for a call so as to correspond to each other, to realize:
a function of storing telephone numbers of phone terminals so as to correspond to email addresses of users of the phone terminals;
a function of receiving the email address of any of the users;
a function of reading the telephone number corresponding to the received email address;
a function of acquiring, from the voice data storage unit, information which specifies the voice data corresponding to the telephone number; and
a function of transmitting the information which specifies the voice data acquired from the voice data storage unit, as an email, to the received email address.

20. A computer readable media which records a program causing a computer to function as a call information providing device, the program causing the computer, connectable to a voice data storage unit which stores voice data indicating content of a call and a telephone number of a phone terminal used for a call so as to correspond to each other, to realize:
a function of storing telephone numbers of phone terminals so as to correspond to email addresses of users of the phone terminals;
a function of acquiring from the voice data storage unit, information which specifies the new voice data and the telephone number corresponding to the new voice data, when the voice data storage unit has stored the new voice data;
a function of reading the email address corresponding to the telephone number acquired from the voice data storage unit; and a function of transmitting the information which specifies the new voice data acquired by the voice data acquisition unit, as an email, to the email address.
